(19) United States
(12) Patent Application Publication
(10) Pub. No.: US 2007/0260037 A1
(43) Pub. Date: Nov. 8, 2007

(54) Azide-containing polymers

(76) Inventor: Ming-Ann Hsu, Damsui Taipei (TW)

Correspondence Address: BIRCH STEWART KOLASCH & BIRCH, PO BOX 747, FALLS CHURCH, VA, 22040-0747, US

(21) Appl. No.: 11/797,303

(22) Filed: May 2, 2007

(30) Foreign Application Priority Data
May 4, 2006 (TW) 95115872

(51) Int. Cl. C08G 73/00

(52) U.S. Cl. 528/422

(57) ABSTRACT

An azide-containing polymer. The azide-containing polymer has formula (I) or (II):

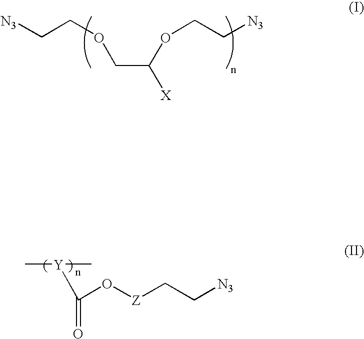

wherein X comprises hydrogen, methyl,

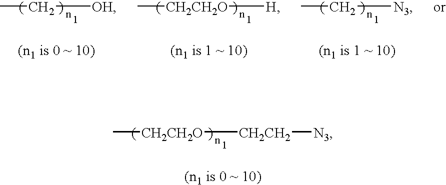

Y comprises acrylate or methacrylate (MA), Z is

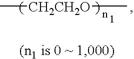

and n is 1˜10,000.

### BACKGROUND OF THE INVENTION

1. Field of the Invention

The invention relates to an azide-containing polymer, and in particular to an azide-containing polymer utilized for biomolecule immobilization.

2. Description of the Related Art

Physical and chemical properties of gel can be controlled by various biomolecules immobilized therein. The biomolecule immobilization can be applied in various bio-technologies such as cell adhesion, affinity chromatography sorbents, or solid-phase biocatalysts. Irradiating to drive chemical reaction can further be applied in biomolecule immobilization due to convenience and accuracy.

After irradiation, active biomolecules are crosslinked with photo-sensitive photo-crosslinker added in gel and then immobilized on substrate. Common photo-crosslinkers are aromatic azide-containing compounds composed of terminal azide and conjugated chemical chains having double bond structure.

During bio-detection, fluorescent light interference produced from conjugated double bond structure after irradiation may reduce signal intensity, resulting in erroneous estimation.

According to researches, it is clear that azide structure is photo-sensitive. Thus, development of a novel azide-containing photo-crosslinker not emitting fluorescent light after irradiation is desirable.

### BRIEF SUMMARY OF THE INVENTION

The invention provides an azide-containing polymer having formula (I) or (II):

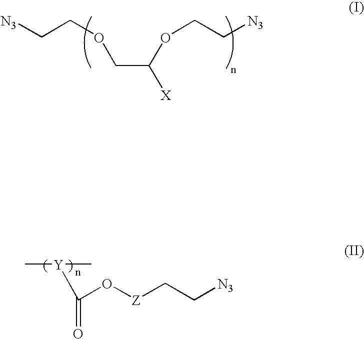

wherein X comprises hydrogen, methyl,

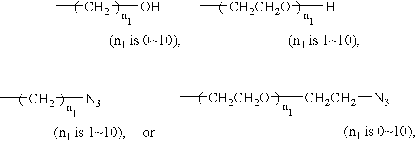

### Y comprises acrylate or methacrylate (MA), Z is

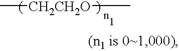

and n is 1˜10,000.

A detailed description is given in the following embodiments.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides an azide-containing polymer having formula (I) or (II):

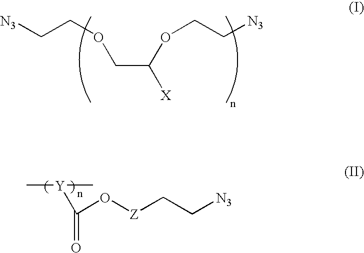

In formula (I), X may comprise hydrogen, methyl,

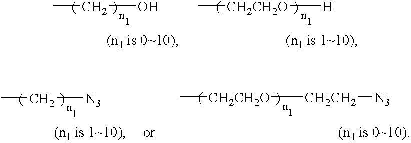

n may be 1˜10,000. In formula (II), Y may be a polymer such as acrylate or methacrylate (MA). Z may comprise

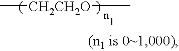

and n is 1˜10,000. In formula (I) and (II), n is preferably 3˜1,000, most preferably 3˜100.

The azide-containing polymer may be a photo-crosslinker, that is, crosslinked with a biomolecule such as protein or peptide by irradiation. The azide-containing polymer has solubility in water exceeding 1%.

The azide-containing polymer is composed of terminal azide and ethylene glycol (EG) derivative. When irradiation is performed, only a crosslinking reaction between the photo-sensitive azide of the polymer and an active biomolecule occurs, without emission of fluorescent light due to the single bond structure of the ethylene glycol derivative. Compared to conventional conjugated double bond structure, background interference is thus significantly reduced, improving bio-detection quality.

The compound having formula (I) is prepared as follows. An ethylene glycol (EG) derivative such as triethylene glycol (TEG) or polyethylene glycol (PEG) and a sulfonyl chloride such as methanesulfonyl chloride (MsCl) or toluenesulfonyl chloride (TsCl) are mixed in a basic solution such as triethyl amine (TEA) to replace the terminal hydroxyl group of the ethylene glycol derivative by Ts or Ms to form a triethylene glycol derivative or a polyethylene glycol derivative containing Ts or Ms. The triethylene glycol derivative or polyethylene glycol derivative is then mixed with an azide salt such as sodium azide in a basic solution such as sodium hydrogen carbonate (NaHCO₃) to prepare the azide-containing compound having formula (I).

The compound having formula (II) is prepared as follows. A polymer containing polyethylene glycol (PEG) side chain, such as polyacrylate-graft-polyethylene glycol, polymethacrylate-graft-polyethylene glycol, sucrose, or polysaccharide, and a sulfonyl chloride such as methanesulfonyl chloride (MsCl) or toluenesulfonyl chloride (TsCl) are mixed in a basic solution such as triethyl amine (TEA) to replace the terminal hydroxyl group of the polymer by Ts or Ms to form a polyacrylate-graft-polyethylene glycol derivative, a polymethacrylate-graft-polyethylene glycol derivative, a sucrose derivative, or a polysaccharide derivative containing polyethylene glycol side chain and terminal Ts or Ms. The polyacrylate-graft-polyethylene glycol derivative, polymethacrylate-graft-polyethylene glycol derivative, sucrose derivative, or polysaccharide derivative containing polyethylene glycol side chain is then mixed with an azide salt such as sodium azide in a basic solution such as sodium hydrogen carbonate (NaHCO₃) to prepare the azide-containing compound having formula (II).

In the invention, biomolecules are immobilized by methods including coating a solution containing an azide-containing polymer on a substrate, distributing biomolecules such as protein or peptide over the substrate, and irradiating the substrate to form a crosslinking structure of the azide-containing polymer and biomolecule, coating a solution containing an azide-containing polymer and biomolecules such as protein or peptide on a substrate, and irradiating the substrate to form a crosslinking structure of the azide-containing polymer and biomolecule, coating a solution containing an azide-containing polymer and biopolymer on a substrate, distributing biomolecules such as protein or peptide over the substrate, and irradiating the substrate to form a crosslinking structure of the azide-containing polymer and biomolecule, and coating a solution containing an azide-containing polymer, biopolymer, and biomolecules such as protein or peptide on a substrate, and irradiating the substrate to form a crosslinking structure of the azide-containing polymer and biomolecule. The added biopolymer may comprise polylactic acid (PLA), polyglycolic acid (PGA), polycaprolactone (PCL), gelatin, agar, saccharide, polyethylene glycol (PEG), polypropylene glycol (PPG), or copolymer thereof.

### EXAMPLE 1

Preparation of Compound 1

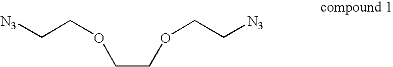

Synthetic Method:

17.5 mL triethylene glycol (TEG) (0.13 mole) was dissolved in 200 mL tetrahydrofuran (THF) to form a triethylene glycol solution. Next, 22.5 mL methanesulfonyl chloride (MsCl) (0.26 mole) and 40.5 mL triethyl amine (TEA) (0.26 mole/50 mL THF) were added thereto and stirred under nitrogen. After stirring for 3.5 hours, 70 mL deionized water was added to dissolve solids and form two liquid layers. 17.44 g sodium azide (0.165 mole) was then added and stirred. After reflux for 24 hours, the aqueous layer was extracted five times by adding 100 mL ether. The five ether layers were then merged, dried by sodium sulfuric acid, filtered, and concentrated. After removing solvent, 13.7 g compound 1 with yield of 52% was prepared. ¹H NMR: δ83.68(m, 8H), 3.40(m, 4H). IR(neat): 2915, 2109 cm⁻¹

### EXAMPLE 2

Preparation of compound 2 (Mw 400 g/mole)

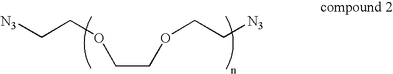

Synthetic Method:

52 g polyethylene glycol (PEG400) (0.13 mole) was dissolved in 200 mL tetrahydrofuran (THF) to form a polyethylene glycol solution. Next, 22.5 mL methanesulfonyl chloride (MsCl) (0.26 mole) and 40.5 mL triethyl amine (TEA) (0.26 mole/50 mL THF) were added thereto and stirred under nitrogen. After stirring for 3.5 hours, 70 mL deionized water was added to dissolve solids and form two liquid layers. 17.44 g sodium azide (0.165 mole) was then added and stirred. After reflux for 24 hours, the aqueous layer was extracted five times by adding 100 mL ether. The five ether layers were then merged, dried by sodium sulfuric acid, filtered, and concentrated. After removing solvent, 17.7 g compound 2 with yield of 30% was prepared. ¹H NMR: δ3.66(m, ˜30H), 3.38(t, 4H). IR(neat): 2955(s), 2900(s), 2856(sh), 2095(s) cm⁻¹.

### EXAMPLE 3

Preparation of Compound 3 (Mw 600 g/mole)

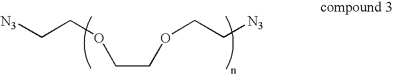

Synthetic Method:

78 g polyethylene glycol (PEG600) (0.13 mole) was dissolved in 300 mL tetrahydrofuran (THF) to form a polyethylene glycol solution. Next, 22.5 mL methanesulfonyl chloride (MsCl) (0.26 mole) and 40.5 mL triethyl amine (TEA) (0.26 mole/50 mL THF) were added thereto and stirred under nitrogen. After stirring for 3.5 hours, 70 mL deionized water was added to dissolve solids and form two liquid layers. 17.44 g sodium azide (0.165 mole) was then added and stirred. After reflux for 24 hours, the aqueous layer was extracted five times by adding 100 mL ether. The five ether layers were then merged, dried by sodium sulfuric acid, filtered, and concentrated. After removing solvent, 23.9 g compound 3 with yield of 27% was prepared. ¹H NMR: δ3.66(m, ˜45H), 3.38(t, 4H). IR(neat): 2956(s), 2902(s), 2092(s) cm⁻¹

### EXAMPLE 4

Preparation of Compound 4 (Mw 900 g/mole)

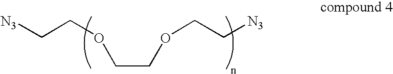

Synthetic Method:

117 g polyethylene glycol (PEG900) (0.13 mole) was dissolved in 500 mL tetrahydrofuran (THF) to form a polyethylene glycol solution. Next, 22.5 mL methanesulfonyl chloride (MsCl) (0.26 mole) and 40.5 mL triethyl amine (TEA) (0.26 mole/50 mL THF) were added thereto and stirred under nitrogen. After stirring for 3.5 hours, 70 mL deionized water was added to dissolve solids and form two liquid layers. 17.44 g sodium azide (0.165 mole) was then added and stirred. After reflux for 24 hours, the aqueous layer was extracted five times by adding 100 mL ether. The five ether layers were then merged, dried by sodium sulfuric acid, filtered, and concentrated. After removing solvent, 36 g compound 4 with yield of 28% was prepared. ¹H NMR: δ3.66(m, ˜66H), 3.38(t, 4H). IR(neat): 2955(s), 2900(s), 2089(s) cm⁻¹.

### EXAMPLE 5

Preparation of Compound 5 (Mw 1500 g/mole)

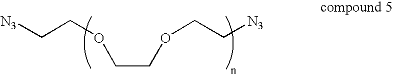

Synthetic Method:

188 g polyethylene glycol (PEG1500) (0.13 mole) was dissolved in 600 mL tetrahydrofuran (THF) to form a polyethylene glycol solution. Next, 22.5 mL methanesulfonyl chloride (MsCl) (0.26 mole) and 40.5 mL triethyl amine (TEA) (0.26 mole/50 mL THF) were added thereto and stirred under nitrogen. After stirring for 3.5 hours, 70 mL deionized water was added to dissolve solids and form two liquid layers. 17.44 g sodium azide (0.165 mole) was then added and stirred. After reflux for 24 hours, the aqueous layer was extracted five times by adding 100 mL ether. The five ether layers were then merged, dried by sodium sulfuric acid, filtered, and concentrated. After removing solvent, 34.4 g compound 5 with yield of 24.3% was prepared. ¹H NMR: δ3.66(m, ˜106H), 3.38(t, 4H). IR(neat): 2948(s), 2900(s), 2087(s) cm⁻¹

### EXAMPLE 6

Preparation of Compound 6 (Mw 3000 g/mole)

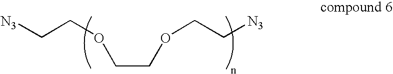

Synthetic Method:

370 g polyethylene glycol (PEG1500) (0.13 mole) was dissolved in 800 mL tetrahydrofuran (THF) to form a polyethylene glycol solution. Next, 22.5 mL methanesulfonyl chloride (MsCl) (0.26 mole) and 40.5 mL triethyl amine (TEA) (0.26 mole/50 mL THF) were added thereto and stirred under nitrogen. After stirring for 3.5 hours, 70 mL deionized water was added to dissolve solids and form two liquid layers. 17.44 g sodium azide (0.165 mole) was then added and stirred. After reflux for 24 hours, the aqueous layer was extracted five times by adding 100 mL ether. The five ether layers were then merged, dried by sodium sulfuric acid, filtered, and concentrated. After removing solvent, 64.4 g compound 6 with yield of 22.7% was prepared. ¹H NMR: δ3.66(m, ˜200H), 3.38(t, 4H). IR(neat): 2954(s) 2907(s), 2095(s) cm⁻¹

### EXAMPLE 7

Preparation of Compound 7

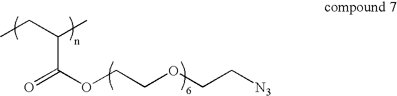

Synthetic Method:

36 g polyacrylate-graft-polyethylene glycol containing polyethylene glycol (PEG) side chain was dissolved in 300 mL tetrahydrofuran (THF) to form a polyacrylate-graft-polyethylene glycol solution. Next, 22.5 mL methanesulfonyl chloride (MsCl) (0.26 mole) and 40.5 mL triethyl amine (TEA) (0.26 mole/50 mL THF) were added thereto and stirred under nitrogen. After stirring for 3.5 hours, 70 mL deionized water was added to dissolve solids and form two liquid layers. 17.44 g sodium azide (0.165 mole) was then added and stirred. After reflux for 24 hours, the aqueous layer was extracted five times by adding 100 mL ether. The five ether layers were then merged, dried by sodium sulfuric acid, filtered, and concentrated. After removing solvent, 12.3 g compound 7 with yield of 34.2% was prepared. IR(neat): 2959(s), 2912(s), 2093(s), 1789(s) cm⁻¹

### EXAMPLE 8

Preparation of Compound 8

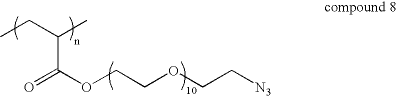

Synthetic Method:

52.6 g polyacrylate-graft-polyethylene glycol containing polyethylene glycol (PEG) side chain was dissolved in 300 mL tetrahydrofuran (THF) to form a polyacrylate-graft-polyethylene glycol solution. Next, 22.5 mL methanesulfonyl chloride (MsCl) (0.26 mole) and 40.5 mL triethyl amine (TEA) (0.26 mole/50 mL THF) were added thereto and stirred under nitrogen. After stirring for 3.5 hours, 70 mL deionized water was added to dissolve solids and form two liquid layers. 17.44 g sodium azide (0.165 mole) was then added and stirred. After reflux for 24 hours, the aqueous layer was extracted five times by adding 100 mL ether. The five ether layers were then merged, dried by sodium sulfuric acid, filtered, and concentrated. After removing solvent, 16.3 g compound 8 with yield of 31% was prepared. IR(neat): 2958(s), 2910(s), 2090(s), 1792(s) cm⁻¹

### EXAMPLE 9

Protein Immobilization (1)

A solution containing compound 8 was coated on a plastic substrate. Next, Octreotide protein was printed on the substrate. The substrate was then irradiated to achieve the protein immobilization, forming a crosslinking structure of compound 8 and Octreotide protein.

### EXAMPLE 10

Protein Immobilization (2)

A solution containing compound 8 and Octreotide protein was coated on a plastic substrate. The substrate was then irradiated to achieve the protein immobilization, forming a crosslinking structure of compound 8 and Octreotide protein.

### EXAMPLE 11

Protein Immobilization (3)

A solution containing compound 2 and polycaprolactone (PCL) was coated on a plastic substrate. Next, Octreotide protein was printed on the substrate. The substrate was then irradiated to achieve protein immobilization, forming a crosslinking structure of compound 2 and Octreotide protein.

### EXAMPLE 12

Protein Immobilization (4)

A solution containing compound 2, polycaprolactone (PCL), and Octreotide protein was coated on a plastic substrate. The substrate was then irradiated to achieve protein immobilization, forming a crosslinking structure of compound 2 and Octreotide protein.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An azide-containing polymer having formula (I) or (II): 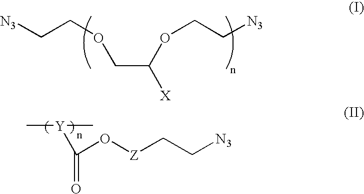
wherein X comprises hydrogen, methyl, 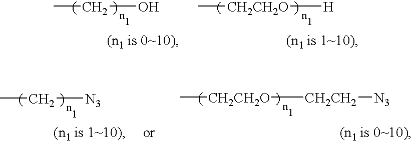
Y comprises acrylate or methacrylate (MA), Z is 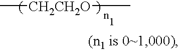
and n is 1˜10,000.

2. The azide-containing polymer as claimed in claim 1, wherein n is 3˜1,000.

3. The azide-containing polymer as claimed in claim 1, wherein n is 3˜100.

4. The azide-containing polymer as claimed in claim 1, wherein the azide-containing polymer has solubility in water exceeding 1%.

5. The azide-containing polymer as claimed in claim 1, wherein the azide-containing polymer is a photo-crosslinker.

6. The azide-containing polymer as claimed in claim 5, wherein the azide-containing polymer is crosslinked with a biomolecule by irradiation.

7. The azide-containing polymer as claimed in claim 6, wherein the biomolecule comprises protein or peptide.
